(19) United States
(12) Patent Application Publication
(10) Pub. No.: US 2010/0158591 A1
(43) Pub. Date: Jun. 24, 2010

(54) Printing Apparatus and Printer Driver

(75) Inventors: Yasushi OTAKI, Matsumoto-shi (JP); Osamu AZAMI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/607,852

(22) Filed: Oct. 28, 2009

(30) Foreign Application Priority Data
Dec. 18, 2008 (JP) 2008-322498

(51) Int. Cl. G03G 15/00; B65H 9/00

(52) U.S. Cl. 399/364; 271/186

(57) ABSTRACT

A printing apparatus that is capable of performing two-sided printing, includes: a sheet determining unit that determines whether a sheet size that has been instructed is smaller than a predetermined standard; a one-sided/two-sided determining unit that determines whether one-sided printing or two-sided printing has been instructed; and a printing/feeding control unit that, in a case where the sheet determining unit has determined that the sheet size is smaller than the predetermined standard and the one-sided/two-sided determining unit has determined that two-sided printing has been instructed, selects short-edge feeding for performing feeding of a sheet having an orientation in which short edges of the sheet are perpendicular to a feeding direction in the printing apparatus and performs printing on the sheet.

### BACKGROUND

1. Technical Field

The present invention relates to a printing apparatus and a printer driver.

2. Related Art

Long-edge feeding (hereafter, LEF) and short-edge feeding (hereafter, SEF) are two examples of sheet-feeding methods used in printing apparatuses. LEF is a method of feeding a sheet with the long edges thereof being perpendicular to the feeding direction (transport direction) in the printing apparatus and SEF is a method of feeding a sheet with the short edges thereof being perpendicular to the feeding direction.

To date, in printing apparatuses, in the case of printing on comparatively small sheets such as postcards or A5 sheets, it has generally been the case that the method of feeding the sheets has been set to LEF or SEF in accordance with the model of the printing apparatus.

Furthermore, printing apparatuses are provided with a feeding tray that is capable of setting the long edge or the short edge of sheets as the transport direction of recording sheets, and a printing control method is known that separates a print job by performing printing using a transport direction that is different from the transport direction of the immediately previous print job. See JP-A-2006-51660, for example.

Moreover, in order to easily perform an operation of sorting recording sheets that have been ejected into an output tray, a longitudinal/lateral sorting method has been disclosed in JP-A-2007-218962, in which in the case of printer output, recording sheets are longitudinally transported and in the case of facsimile output, the recording sheets are laterally transported, and thus the recording sheets are sorted.

When using a printing apparatus, users sometimes wish to select, as a printing method, one-sided printing or two-sided printing. However, in the case where the feeding method for small sheets, such as those described above, has been set to LEF or SEF, sometimes it has been the case that a user cannot freely select the printing method (one-sided printing or two-sided printing), or even if the user can freely select the printing method, the performance of the printing apparatus (for example, the ppm value, which is the number of pages the printing apparatus prints in one minute) is decreased.

Specifically, in a printing apparatus in which the feeding method for the small sheets has been set to LEF, when performing printing on these small sheets, sometimes the user cannot select two-sided printing (the user is forced to select one-sided printing). This is because, due to the structure of the mechanism that turns over and transports a sheet in order to perform two-sided printing, sheets for which the length of the sides thereof parallel to the transport direction is too short cannot be stably transported.

On the other hand, in a printing apparatus in which the feeding method has been set to SEF, when using the small sheets, although one-sided printing or two-sided printing can be selected, the above-described decrease in performance becomes a problem. In a printing apparatus, in the case where the maximum printable size has been determined on the basis of the model of the printing apparatus, and the printing apparatus sequentially transports and performs printing on sheets, as long as the size of the sheets is within the dimension of the maximum size in the transport direction, a plurality of sheets can be made print targets at the same time. In other words, it can be said that with LEF a greater number sheets fit within the above-described maximum size than with SEF and the performance of the printing apparatus is easily increased. However, as described above, in the case where the feeding method has been set to SEF, while there is an advantage that two-sided printing can be selected, at the same time, a disadvantage arises in that the performance of printing is decreased, particularly when a user has selected one-sided printing.

Furthermore, in both of the above-cited patent documents, the lack of freedom in selecting a printing method and the decrease in performance when printing on the above-described small-sized sheets is not solved.

### SUMMARY

An advantage of some aspects of the invention is that it provides a printing apparatus and a printer driver that, when performing printing on certain small sheets, are capable of responding to a desire of a user to freely select one-sided printing or two-sided printing and realizing increased efficiency of printing.

In order to achieve the above-described advantage, a printing apparatus that is capable of performing two-sided printing, according to an aspect of the invention includes: a sheet determining unit that determines whether a sheet size that has been instructed is smaller than a predetermined standard; a one-sided/two-sided determining unit that determines whether one-sided printing or two-sided printing has been instructed; and a printing/feeding control unit that in a case where the sheet determining unit has determined that the sheet size is smaller than the predetermined standard and the one-sided/two-sided determining unit has determined that two-sided printing has been instructed, selects short-edge feeding for performing feeding of a sheet having, an orientation in which short edges of the sheet are perpendicular to a feeding direction in the printing apparatus and performs printing on the sheet. According to the aspect of invention, in the case of performing printing on a sheet of a size smaller than the predetermined standard, when two-sided printing has been instructed, short-edge feeding is performed, and therefore two-sided printing can be performed with certainty when a sheet of a size that is smaller than the predetermined standard is used.

In a case where the sheet determining unit has determined that the instructed sheet size is smaller than the predetermined standard and the one-sided/two-sided determining unit has determined that one-sided printing has been instructed, the printing/feeding control unit, may preferentially select long-edge feeding for performing feeding of a sheet having an orientation in which the long edges of the sheet are perpendicular to the feeding direction in the printing apparatus, rather than short-edge feeding, and then perform printing on the sheet. According to this printing apparatus, in the case of performing printing on sheets of a size that is smaller than the predetermined standard, when one-sided printing has been instructed, basically long-edge feeding is performed, and therefore printing can be efficiently performed on sheets of a size smaller than the predetermined standard.

The printing apparatus further includes a two-sided-printing transporting mechanism that turns over a sheet for which printing on one side thereof has been completed and transports the sheet to a predetermined printing start position. The sheet determining unit may determine that the size of the sheet is smaller than the predetermined standard in a case where the short edges of the sheet are shorter than the distance between transport rollers included in the two-sided-printing transporting mechanism. According to the printing apparatus, the sheet determining unit can determine that a sheet of a size that cannot be transported by the two-sided-printing transporting mechanism when long-edge feeding is performed, is a sheet of a size that is smaller than the predetermined standard.

The printing/feeding control unit, together with obtaining image data oriented in a certain direction that becomes a print target, in a case where the orientation of the sheet in the selected feeding and the orientation of the image data do not match, may rotate the image data so that the orientation of the sheet and the orientation of the image data match and perform printing on the basis of the rotated image data. According to the printing apparatus, on the side that supplies image data (for example, the host computer that controls the printing apparatus), without considering the orientation of sheets in feeding, image data oriented in a certain direction is simply created and output. On the other hand, when the printing/feeding control unit obtains a print command from outside and creates image data by interpreting the print command, the printing/feeding control unit creates image data oriented in a direction that matches the sheet orientation for the selected feeding and performs printing on the basis of the created print data.

The printing/feeding control unit may determine whether there is a sheet that has an orientation that corresponds to the sheet orientation for the selected feeding and is of the sheet size that has been instructed in a predetermined feeding device, and in the case where there is such a sheet, the printing/feeding control unit may cause the sheet to be fed from the feeding device and perform printing on the sheet, and in the case where there is no such sheet, the printing/feeding control unit may make a request to the outside that such a sheet be provided to the feeding device. According to the printing apparatus, in the case where, in the feeding device, there is no sheet that has an orientation that corresponds to the sheet orientation for the selected feeding and is of the sheet size that has been instructed, the user can be asked to provide such a sheet and, as a result, printing (two-sided printing or one-sided printing) is performed in accordance with a desire of the user.

The printing/feeding control unit may perform determination of whether or not there is a sheet in the feeding device that has an orientation that corresponds to a sheet orientation for the selected feeding and is of the instructed sheet size after obtaining image data that is oriented in a direction that matches the sheet orientation for the selected feeding. According to the printing apparatus, since the printing/feeding control unit determines whether or not there is a target sheet just before printing based on the image data is performed, an inconvenience can be avoided, of there being no target sheets when printing is actually performed, after having determined that there is a target sheet.

A technical idea of an aspect of the invention can also be applied to things other than printing apparatuses and for example can be also applied to software to be executed in a computer that controls a printing apparatus. As an example thereof, a printer driver can be considered that, in a computer, implements: a sheet determining function that determines whether a sheet size that has been instructed is smaller than a predetermined standard; a one-sided/two-sided determining function that determines whether one-sided printing or two-sided printing has been instructed; and a control function that, in a case where the sheet determining function has determined that the sheet size is smaller than the predetermined standard and the one-sided/two-sided determining function has determined that two-sided printing has been instructed, together with creating image data that is oriented in a direction that matches a sheet orientation for short-edge feeding for performing feeding of a sheet having an orientation in which short edges of the sheet are perpendicular to a feeding direction in a printing apparatus, causes two-sided printing of the image data and short-edge feeding to be performed in the printing apparatus, which is a control target, on a sheet of the sheet size. Furthermore, the scope of the invention can be extended to include a method or a program that includes steps or functions that correspond to the individual components of the above-described printing apparatus and the scope of the invention can be extended to include an apparatus or a method that includes components or steps that correspond to the individual functions of the above-described printer driver. Still furthermore, the scope of the invention can be extended to include a printing system that includes the above-described host computer and printing apparatus.

### BRIEF DESCRIPTION OF THE DRAWINGS

The invention will be described with reference to the accompanying drawings, wherein like numbers reference like elements.

FIG. 1 is a block diagram illustrating an outline of a configuration of a printer according to embodiments.

FIG. 2 is a flowchart illustrating processing according to a first embodiment.

FIG. 3 is view illustrating an example of image data in a landscape orientation.

FIG. 4 is a perspective view illustrating part of a two-sided-printing transporting mechanism.

FIG. 5 is a view illustrating an example of a relationship between a maximum size and a sheet.

FIG. 6 is a view illustrating another example of the relationship between the maximum size and a sheet.

FIG. 7 view illustrating a further example of the relationship between the maximum size and a sheet.

FIG. 8 is a flowchart illustrating processing according to a second embodiment.

### DESCRIPTION OF EXEMPLARY EMBODIMENTS

### 1. Outline Configuration of Printer

Hereafter, embodiments of the invention will be described with reference to the drawings.

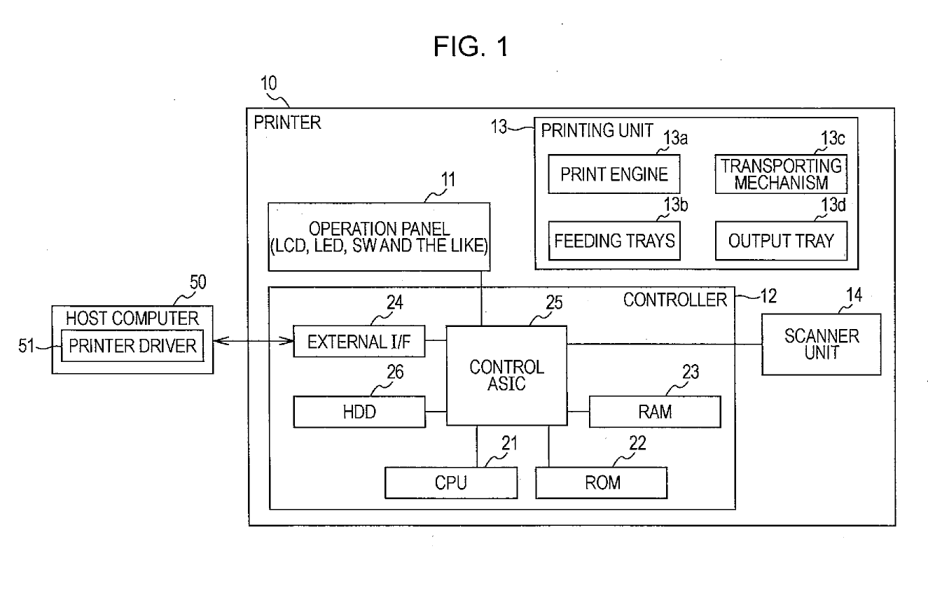

FIG. 1 illustrates an outline configuration of a printer 10 according to an embodiment in the form of a block diagram. The printer 10 corresponds to an example of the printing apparatus according to the aspect of the invention. In the present embodiment, description of the printer 10 will be made by taking a multifunction machine including a scanner function and a copier function in addition to a printer function as an example, but the printer 10 is not necessarily a multifunction machine.

The printer 10 includes an operation panel 11, a controller 12, a printing unit 13, and a scanner unit 14, and functions as a page printer. The operation panel 11 is a unit for receiving various instructions from a user and for showing the status of the printer 10 to the user. The operation panel 11, for example, includes a liquid crystal display (LCD), LEDs, and push-button switches SW. The controller 12 is a unit for controlling each component of the printer 10 and includes a CPU 21, a ROM 22, a RAM 23, a external interface (I/F) 24, a control ASIC 25, and a HDD 26.

In the controller 12, while using the RAM 23 as a memory, the CPU 21 performs various control processing operations that follow predetermined programs stored in the ROM 22. Furthermore, the control ASIC 25 is an ASIC (ASIC developed for use in the printer 10) that performs transmitting of data among the various components of the printer 10 (CPU 21, ROM 22, RAM 23, external I/F 24, HDD 26, operation panel 11, printing unit 13, scanner unit 14 and the like).

The external I/F 24, for example, connects a host computer 50 and the printer 10 through a network such as a LAN or the like. In the host computer 50, a printer driver 51 for controlling driving of the printer 10 is installed.

The scanner unit 14 is an image scanner provided with an operation panel (not illustrated) that includes a numeric keypad and an LCD. In the case where an operation has been performed that instructs initiation of copying or scanning through the operation panel, the scanner unit 14 creates image data of an original, which has been set on the scanner unit 14 itself, by reading the original by performing scanning thereon, and sends the image data to the controller 12. The controller 12 saves the image data in the HDD 26 and makes the image data a target of printing. The printing unit 13 is a unit that performs printing on a sheet on the basis of data and commands sent from the host computer 50 and the scanner unit 14 to the controller 12, and includes a print engine 13a, a plurality of feeding trays (feeding devices) 13b, a transporting mechanism (including a two-sided-printing transporting mechanism) 13c, and an output tray 13d.

### 2. First Embodiment

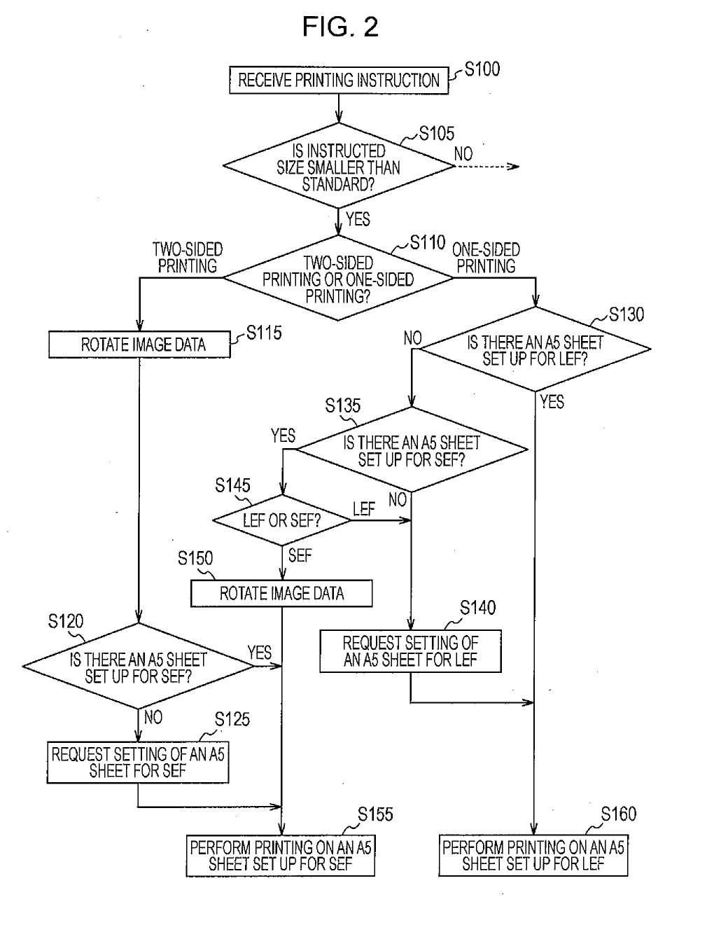

FIG. 2 illustrates, in the form of a flowchart, processing mainly performed by the controller 12 in accordance with a predetermined program in the printer 10 that has received transmission of data from the host computer 50. Hereafter, an embodiment to be described with reference to FIG. 2 will be referred to as a first embodiment.

In the first embodiment, the host computer 50 sends bitmap data (image data) that represents an image of a print target using colors (cyan, magenta, yellow, black and the like) which the print engine 13a uses, to the printer 10 together with predetermined printing setting information. The image data is created by the printer driver 51 on the basis of an image file arbitrarily selected by a user as a print target by operating the host computer 50.

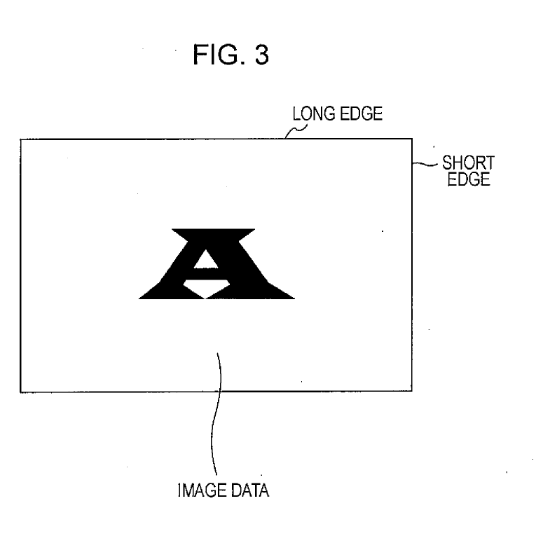

Image data that the host computer 50 sends to the printer 10 is oriented in a certain direction and, in the first embodiment, as illustrated in FIG. 3, the image data is assumed to always be in a landscape orientation (short edges oriented vertically, long edges oriented horizontally). In other words, assuming that a sheet is subjected to LEF, the printer driver 51 creates image data of an orientation that corresponds to LEF and sends the created image data to the printer 10. The printing setting information is, for example, information that specifies a sheet size of sheets to be supplied in printing, a printing method (one-sided printing or two-sided printing) and the like, and is formed in accordance with an operation of the host computer 50 of the user and related settings.

Under such an assumption, once the controller 12 has received a printing instruction along with transmission of data from the host computer 50 (printer driver 51) in step S (hereafter, “step” is omitted) 100 through the external I/F 24, in S105, the controller 12 determines whether or not the sheet size that is specified in the printing setting information (also referred to as “specified sheet size”) is smaller than the predetermined standard. That is, in the case where the controller 12 has set the feeding method to LEF, the controller 12 determines whether the specified size is too small such that the sheet cannot be transported by the two-sided-printing transporting mechanism.

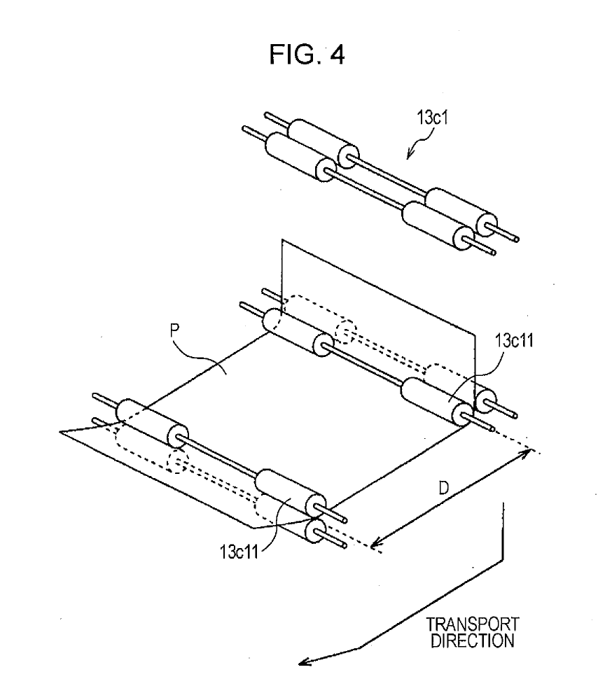

FIG. 4 illustrates an example of part of the two-sided-printing transporting mechanism 13c1 included in the transporting mechanism 13c. The two-sided-printing transporting mechanism 13c1 is a mechanism that turns over (reverses) a sheet P for which printing on one side thereof by the print engine 13a has been completed and transports the sheet P once more to the printing start position in the print engine 13a, and transport rollers 13c11 are arranged at a predetermined interval in the transport path. In order for the two-sided-printing transporting mechanism 13c1 to stably transport the sheet P, it is necessary that the length of the sheet P in the transport direction is greater than a distance D between the transport rollers 13c11 (more accurately, greater than the maximum distance between adjacent transport rollers 13c11). Therefore, it can be said that a sheet P having short edges whose length that is smaller than the distance D between the transport rollers 13c11 is of an insufficient size to be transported by the two-sided-printing transporting mechanism 13c1 in a LEF state.

Here, in S105, the controller 12 compares the distance D between the transport rollers 13c11, provided as information in advance, and the length of the short edge of the sheet of the specified size, and, in the case where the length of the short edge is smaller, determines that the specified size is smaller than the predetermined standard. Alternatively, rather than performing the above comparison, the controller 12 may possess, as information provided in advance, sheet sizes whose short edges are shorter than the distance D and in the case where the specified size is included in these sheet sizes, may determine that the specified size is smaller than the predetermined standard. In the first embodiment, as concrete examples, postcard, A5, half-letter sizes and the like correspond to sizes that are smaller than the predetermined standard. The controller 12 advances to S110 in the case where it has determined that the specified size is smaller than the predetermined standard. The controller 12 can be said to function as the sheet determining unit in that it is capable of performing the determination of S105.

Hereafter, description of the embodiment will continue assuming that the specified size is smaller than the standard, and for convenience, it will be assumed that the specified size is A5 (an example of a size smaller than the predetermined standard). In S110, the controller 12 determines whether one-sided printing or two-sided printing has been instructed as a printing method. The controller 12 performs the determination by referring to the printing setting information. In the case where two-sided printing has been instructed, the controller 12 advances to S115, and in the case where one-sided printing has been instructed, the controller 12 advances to S130. The controller 12 can be said to function as the one-sided/two-sided determining unit in that it is capable of performing the determination of S110.

In S115, the controller 12 performs processing to rotate the image data. In other words, as a result of the determinations of S105 and S110, the controller 12 determines that SEF should be selected as the feeding method, and therefore rotates the image data of a landscape orientation (orientation for LEF) 90° to obtain data suitable for SEF. In the rotation processing, the controller 12 may divide the image data into a plurality of pieces of band data of a predetermined width by using lines parallel to the short edges of the image and rotate the image data in units of band data.

In S120, the controller 12 determines whether or not there is a sheet in any of the feeding trays 13b that has been set in an orientation corresponding to SEF, and in the case where there is such a sheet, advances to S155, and in the case where there is no such sheet, advances to S125. The controller 12 performs the determination of S120 by querying whether there is such a sheet in any of the feeding trays 13b in the printing unit 13.

In S125, the controller 12 requests that an A5 sheet oriented so as to correspond to SEF be set in one of the feeding trays 13b. Specifically, the controller 12 causes a message detailing this request to be displayed on the LCD of the operation panel 11 and notifies the host computer 50 of the request and the host computer 50 causes the message detailing the request to be displayed on a monitor thereof. The user recognizes that an A5 sheet should be set in the feeding tray 13b in an orientation that corresponds to SEF by seeing the message.

After determination of “Yes” in S120 or after S125, the controller 12 causes printing of the image data on an A5 sheet using SEF to be performed by controlling the printing unit 13 (S155). After determination of “Yes” in S120 or after S125, it goes without saying that two-sided printing is adopted as the printing method. Consequently, the controller 12, together with sequentially sending the image data in units of band data to the print engine 13a, realizes formation of the image on a sheet by causing feeding from the feeding tray 13b holding an A5 sheet having an orientation that corresponds to SEF to start and by causing the transporting mechanism 13c which includes the two-sided-printing transporting mechanism 13c1 to operate. After S125, after detecting that an A5 sheet has actually been set in the feeding tray 13b in an orientation which corresponds to SEF, the controller 12 advances to S155. In the case where the controller 12 has not been able to detect for at least a predetermined period of time that an A5 sheet has been set in the feeding tray 13b in an orientation which corresponds to SEF and has received an instruction for stopping of printing through the operation panel 11 or the like, the controller 12 may cause ending of the processing shown in the flowchart, rather than advancing to S155.

In S130, the controller 12 determines whether or not there is an A5 sheet having an orientation corresponding to LEF in any of the feeding trays 13b. In other words, as a result of the determinations of S105 and S110, the controller 12 determines that LEF should be preferentially selected as the feeding method, and consequently determines whether or not there is an A5 sheet having an orientation which corresponds to LEF in any of the feeding trays 13b by querying the printing unit 13 in a similar manner to in S120.

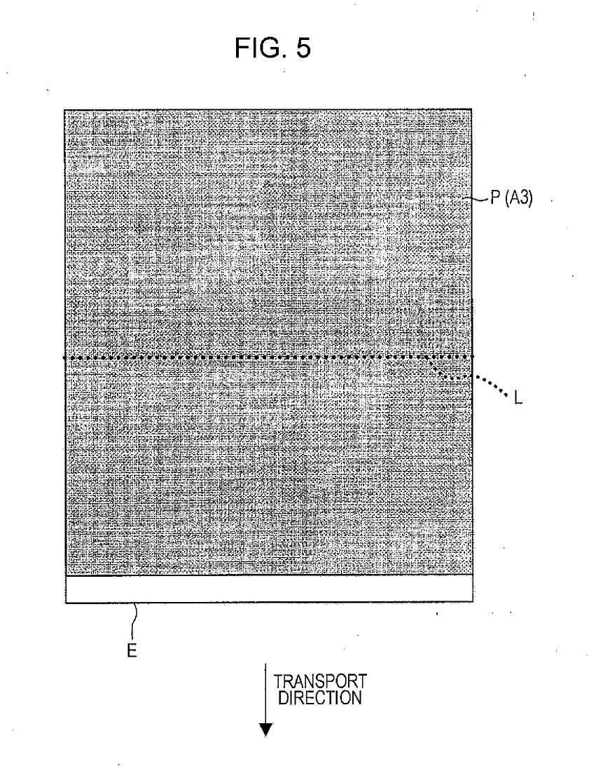

FIG. 5 illustrates an example of the relationship between a maximum size E that can be printed due to the structure of the print engine 13a and a sheet P. The maximum size E is shown by the rectangular outer frame and in the first embodiment is a size having long edges somewhat longer than those of an A3 sheet P (shaded gray portion). However, the maximum size E differs depending on the model of the printer 10.

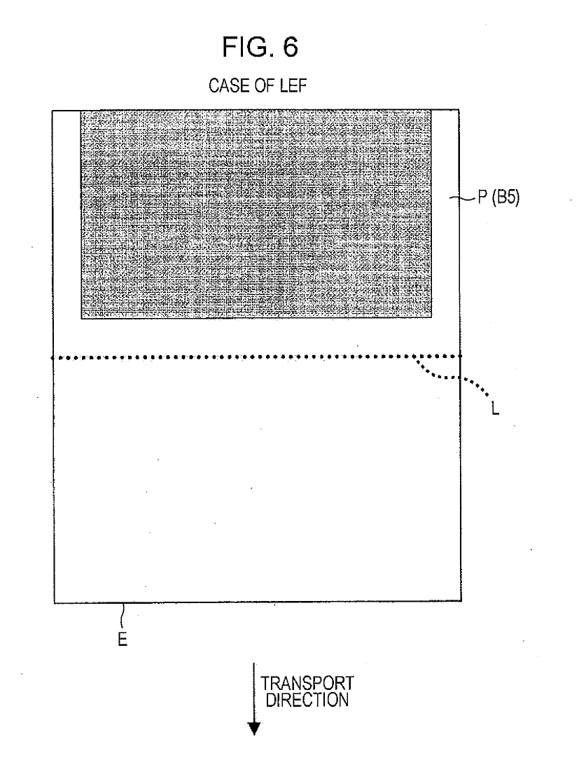

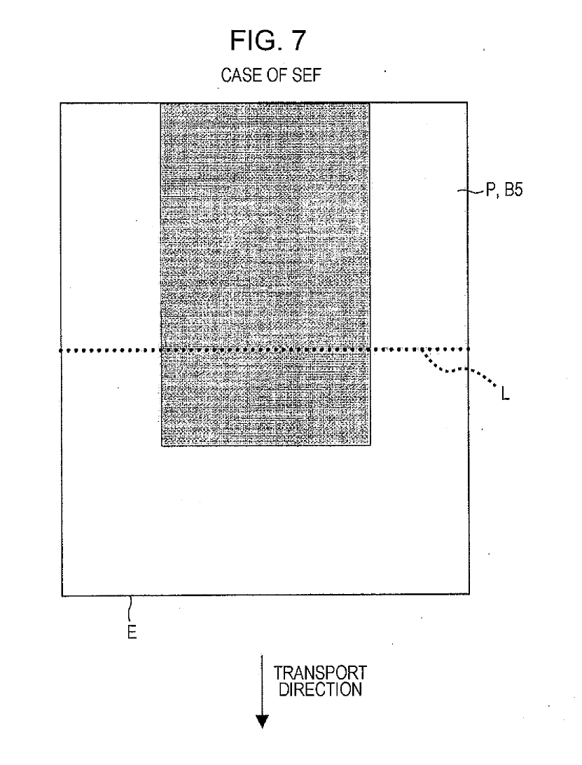

FIGS. 6 and 7 illustrate the maximum size E similarly to FIG. 5, and within the maximum size E a broken line L is shown that divides the maximum size E in a direction perpendicular to the transport direction. In FIG. 6, an example is illustrated in which a sheet P of B5 size has been arranged within the maximum size E in a state in which LEF has been performed, and in FIG. 7, the sheet P of B5 size has been arranged within the maximum size E in a state in which SEF has been performed. Referring to FIGS. 6 and 7, provided that the sheet P is of a size equal to or smaller than half the maximum size E, once the sheet P has been aligned with the transport direction, together with it being possible for two sheets to fit within the maximum size E, it can be said that when LEF is set as the feeding method there is a higher possibility that two sheets P fit into the maximum size E (not limited to B5) than when SEF is set.

In the case where two sheets fit within the maximum size E, the printer 10 can perform printing in a so-called two-up printing mode. The two-up printing mode is a mode in which two sheets are fed to the print engine 13a, processing for forming two pages of toner images of individual colors of ink on a transfer medium of the print engine 13a is sequentially performed, and the two sheets that have been subjected to color printing are output, and the printing efficiency is improved compared with the case where one sheet is fed to the print engine 13a and printing is performed thereon. Here, in the first embodiment, in a case that is not a situation where SEF has to be used for two-sided printing, basically LEF is preferentially selected over SEF and it is ensured that the performance of printing is easily improved. As a premise of the present embodiment, the portion of the transporting mechanism 13c not including the two-sided-printing transporting mechanism 13c1 (portion of the mechanism that operates to transport a sheet during one-sided printing) is assumed to be capable of transporting a sheet of a size smaller than the predetermined standard in either of an LEF orientation and an SEF orientation.

The controller 12 advances to S160 in the case where there is an A5 sheet having an orientation which corresponds to LEF in any of the feeding trays 13b, and advances to S135 in the case where there is no such sheet in any of the feeding trays 13b. In S135, similarly to in S120, the controller 12 determines whether or not there is an A5 sheet that has been set in an orientation which corresponds to SEF in any of the feeding trays 13b, and in the case where there is such a sheet, advances to S145 and in the case where there is no such sheet, advances to S140.

In S140, the controller 12 makes a request to the outside that an A5 sheet should be set in one of the feeding trays 13b in an orientation which corresponds to LEF. A user recognizes the fact that an A5 sheet has to be set in the feeding tray 13b in an orientation that corresponds to LEF by receiving the request.

After the determination of “Yes” in S130 or after S140, the controller 12 causes one-sided printing of the image data to be performed on an A5 sheet using LEF by controlling the printing unit 13 (S160). That is, the controller 12, together with dividing the image data into band data by using lines that are parallel to the long edges of the image and sequentially sending the image data in units of the band data to the print engine 13a, realizes formation of the image on a sheet by causing feeding from the feeding tray 13b holding an A5 sheet having an orientation which corresponds to LEF to start and causing the portion of the transporting mechanism 13c not including the two-sided-printing transporting mechanism 13c1 to operate. After S140, the controller 12 advances to S160 after determining that an A5 sheet has actually been set in the feeding tray 13b in an orientation that corresponds to LEF. The controller 12, after S140, in the case where the controller 12 has not been able to detect for at least a predetermined period of time that an A5 sheet has been set in the feeding tray 13b in an orientation which corresponds to LEF and has received an instruction for stopping of printing through the operation panel 11 or the like, the controller 12 may cause the processing shown in the flowchart to end, rather than advancing to S160.

In S145, the controller 12 receives a selection of the feeding method. For example, provided that there is an A5 sheet having an orientation that corresponds to SEF, together with informing the user of the existence the A5 sheet having an orientation which corresponds to SEF in the feeding tray 13b, the controller 12 causes a message asking which of LEF and SEF is to be selected to be displayed on the LCD of the operation panel 11 and on the monitor of the host computer 50. The user instructs the controller 12 through the operation panel 11 or the like whether to use the A5 sheet that is currently set as is (selection of SEF), or whether to set a sheet having an orientation corresponding to LEF in the feeding tray 13b (selection of LEF) and the controller 12 receives an instruction concerning the selection. The controller 12 advances to S140 in the case where selection of LEF is received in S145 and advances to S150 in the case where selection of SEF is received in S145.

In S150, similarly to in S115, after performing rotation processing on the image data to produce data that is suitable for SEF, the controller 12 advances to S155. In S155 after S150, together with sequentially sending the image data to the print engine 13a in units of band data, the controller 12 realizes formation of the image on a sheet by causing feeding from the feeding tray 13b that holds the A5 sheet having an orientation which corresponds to SEF to start and causing the portion of the transporting mechanism 13c not including the two-sided-printing transporting mechanism 13c1 to operate (one-sided printing).

In this way, in the first embodiment, in the case where one-sided printing has been instructed, first, a sheet having an orientation that corresponds to LEF is preferentially used, and in the case where there are temporarily no sheets of the specified size that have an orientation that corresponds to LEF in the feeding trays 13b at that time, the controller 12 determines whether or not there is a sheet of a specified size that has an orientation that corresponds to SEF, and in the case where there is no sheet of the specified size that has an orientation that corresponds to SEF, the controller 12 makes a request to the user to a provide sheet that is of the specified size and has an orientation that corresponds to LEF. On the other hand, in the case where there is a sheet of the specified size that has an orientation that corresponds to SEF, the user can select whether to provide a sheet that is of the specified size and has an orientation corresponding to LEF. In other words, at the time of one-sided printing, basically, while stressing printing efficiency and prioritizing LEF, a user is also given freedom to select the printing method in accordance with the presence or absence of sheets at that time.

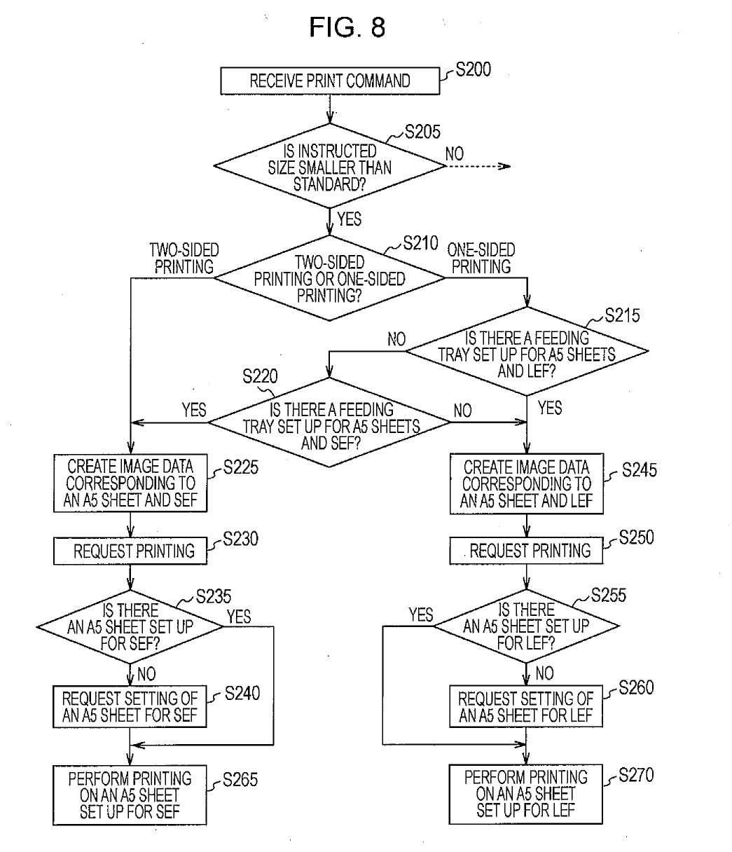

Furthermore, in the first embodiment, the printer 10 determines whether to use LEF or SEF, and causes the orientation of the image data sent from the host computer 50 to match the sheet orientation for the determined feeding method (causing the image data to be rotated as necessary). Consequently, on the host computer 50 (printer driver 51) side, image data can be formed and output without consideration of whether the sheet orientation and the orientation of the image match. Above, the image data that the host computer 50 sends to the printer 10 was assumed to be set in a landscape orientation, but needless to say the image data may be set in a portrait orientation (short edges are horizontal, long edges are vertical). In this case, in the flowchart illustrated in FIG. 2, S115 and S150 become necessary and immediately before S160 it is necessary to include processing to rotate the image data such that the orientation of the image data is made to match the sheet orientation for LEF. The controller 12 can be said to function as the printing/feeding controlling unit, in that it performs processing of the flowchart illustrated in FIG. 2 (and the below-described FIG. 8).

### 3. Second Embodiment

FIG. 8 illustrates, in the form of a flowchart, processing mainly performed by the controller 12 in accordance with a predetermined program in the printer 10 that has received transmission of a print command from the host computer 50. Hereafter, an embodiment described with reference to FIG. 8 will be referred to as a second embodiment.

In the second embodiment, the host computer 50 (the printer driver 51), together with converting an image file arbitrarily selected by a user as a print target into print data written in a predetermined page description language, creates a print command including the print data and printing setting information (information on the specified sheet size, printing method and the like) and sends the print command to the printer 10.

Once the controller 12, in S200, has received the print command from the host computer 50 (the printer driver 51) through the external I/F 24, in S205, similarly to in S105, the controller 12 refers to the printing setting information and determines whether the specified size is smaller than the predetermined standard. In the case where the specified size is smaller than the predetermined standard, the controller 12, in step S210, similarly to in S110, refers to the printing setting information and determines whether one-sided printing or two-sided printing has been specified. In the case where two-sided printing has been specified, the controller 12 advances to S225 and in the case where one-sided printing has been specified, the controller 12 advances to S215. In the second embodiment, the specified size is also A5.

In S225, as a result of the determinations of S205 and S210, the controller 12 determines that SEF has to be selected as the feeding method. Then, when analyzing the print data written in the page description language included in the print command and developing the print data into image data, the controller 12 develops the print data into image data that corresponds to a sheet orientation (portrait) for A5 (example of a size smaller than the standard) and SEF. Furthermore, the controller 12 divides the image data into a plurality of pieces of band data of a predetermined width by using lines which are parallel to the short edges of the image.

In S230, the controller 12 makes a printing request to the print engine 13a. At this time, the controller 12 sends the image data to the print engine 13a in units of band data. S235, S240, and S265 are the same as the above-described S120, S125 and S155, respectively. That is, in S265, in the case where the controller 12 causes feeding from the feeding tray 13b holding an A5 sheet having an orientation corresponding to SEF to start and two-sided printing has been instructed, the controller 12 causes the transporting mechanism 13c including the two-sided-printing transporting mechanism 13c1 to operate and thus the controller 12 causes two-sided printing of image data to be performed on an A5 sheet using SEF.

In S215, as a result of determinations of S205 and S210, the controller 12 determines that LEF should be preferably selected over SEF as the feeding method and determines whether or not there is a feeding tray 13b set up to feed A5 sheets having an orientation corresponding to LEF among the plurality of feeding trays 13b (whether the printing unit 13 possesses such a feeding tray 13b). The determination is performed by querying the printing unit 13 that manages attributes and settings of each of the feeding trays 13b. The controller 12 advances to S245 in the case where there is a feeding tray 13b that is set to feed A5 sheets having an orientation corresponding to LEF and advances to S220 in the case where there is no such feeding tray 13b.

In S245, the controller 12 analyzes the print data written in the page description language included in the print command and develops the print data into image data. At this time, the controller 12 develops the print data into image data that corresponds to a sheet orientation (landscape) for A5 and LEF. Furthermore, the controller 12 divides the image data into a plurality of pieces of band data of a predetermined width by using lines that are parallel to the long edges of the image.

In S250, the controller 12 makes a print request to the print engine 13a. At this time, the controller 12 sends the image data to the print engine 13a in units of band data. In S255, the controller 12 determines whether there is a sheet (A5 sheet having an orientation which corresponds to LEF) in the feeding tray 13b detected in S215 and advances to S270 in the case where there is such a sheet and advances to S260 in the case where there is no such sheet.

In S260, the controller 12, similarly to in S140, makes a request to the outside that an A5 sheet should be set in one of the feeding trays 13b in an orientation that corresponds to LEF.

After determination of “Yes” in S255 or after S260, the controller 12 causes one-sided printing of the image data to be performed on an A5 sheet using LEF by controlling the printing unit 13 (S270). That is, the controller 12 causes one-sided printing of the image data to be performed on an A5 sheet using LEF in the printing unit 13 by causing feeding from the feeding tray 13b holding an A2 sheet having an orientation corresponding to LEF to start and causing the portion of the transporting mechanism 13c not including the two-sided-printing transporting mechanism 13c1 to operate.

In S220, the controller 12 determines whether or not there is a feeding tray 13b set to feed A5 sheets having an orientation corresponding to SEF among the plurality of feeding trays 13b and advances to S225 in the case where there is a feeding tray 13b that is set to feed A5 sheets having an orientation corresponding to SEF and advances to S245 in the case where there is no such feeding tray 13b. In S265, after determination of “Yes” in S220, the controller 12 causes one-sided printing of image data to be performed on an A5 sheet using SEF in the printing unit 13, by causing feeding from the feeding tray 13b holding an A5 sheet having an orientation corresponding to SEF to start and by causing the portion of the transporting mechanism 13c not including the two-sided-printing transporting mechanism 13c1 to operate.

In this way, in the second embodiment, in the case of one-sided printing, first, the controller 12 checks whether or not there is a feeding tray 13b that is set to feed sheets of the specified size that have an orientation that corresponds to LEF and then after confirming that there is such a feeding tray 13a, performs development of the print data from page description language into image data. Then, after the image data has been obtained, the controller 12 checks whether or not there is a sheet of the specified size that has an orientation corresponding to LEF in the feeding tray 13b. In the period from when the printer 10 receives a print command from the host computer 50 until when the controller 12 completes developing the print data into image data, in the printer 10, printing of a print job obtained before the print command is possible. That is, even if existence of a desired sheet has been confirmed before the system is ready to complete development of print data into image data and initiate printing (at the time of S215), in actuality, at the point in time when development of the print data into image data is complete and printing is initiated, there is also a possibility that the desired sheet has already been consumed. Here, as described above, after the image data has been obtained (after S245), in other words, at a time immediately before performance of printing, by checking whether or not there is a desired sheet, a situation in which there is no desired sheet when the controller 12 attempts to cause the print engine 13a to operate can be avoided.

In the case where the controller 12 is provided with a structure that is capable of detecting the number of currently remaining sheets by for example counting the number of previously printed sheets, the number of remaining target sheets (sheets of A5 size and set up for LEF) may be detected directly, without determining in S215 whether or not there is there is a feeding tray 13b that is set to feed A5 sheets having an orientation corresponding to LEF. Then, if the number of remaining target sheets can cover the number of sheets necessary for a print job for which printing is currently progressing (print job that uses sheets of A5 size having an orientation that corresponds to LEF) and can cover printing to be performed next of the image data to be created in S245, the controller determines “Yes” in S215 and advances to S245. In this case, the processing of S255 and S260 is not necessary.

Furthermore, in the second embodiment, in the case where there is no feeding tray 13b that has been set to feed sheets of the specified size that have an orientation that corresponds to LEF, the controller 12 determines whether or not there is a feeding tray 13b that has been set to feed sheets of the specified size that have an orientation corresponding to SEF and in the case where there is also no such feeding tray 13b (“No” in S220), makes a request to the user to provide a sheet of the specified size that has an orientation corresponding to LEF. The “request” means a request to provide a sheet of the specified size that has an orientation corresponding to LEF to a feeding tray 13b that has not been used in feeding of sheets of the specified size thus far. On the other hand, in the case where there is a feeding tray 13b that has been set to feed sheets of the specified size that have an orientation that corresponds to SEF, the controller 12 performs printing using SEF. That is, at the time of one-sided printing, basically, while stressing printing efficiency and prioritizing LEF, in accordance with whether there is a feeding tray 13b that has been set to feed sheets of the specified size that have an orientation that corresponds to SEF, the controller 12 appropriately selects LEF or SEF.

In addition, in the second embodiment, the printer 10 is configured to preferentially feed sheets of the specified size that have an orientation corresponding to LEF in the case of one-sided printing (from S215); however, in the case where a certain feeding tray 13b and LEF or SEF have been specified by a user, feeding may be appropriately performed in accordance therewith. That is, in the case where a certain feeding tray 13b has been specified in advance by a user, after determining that one-sided printing is to be performed (S210), the controller 12 causes feeding from the specified feeding tray 13b to start and performs printing. Furthermore, in the case where LEF or SEF has been specified by a user, after determining that one-sided printing is to be performed, the controller 12 causes feeding of sheets from any of the feeding trays 13b to start using the set feeding method and performs printing.

Above, an apparatus that mainly performs the processing of the second embodiment has been described as being the printer 10 (controller 12), but processing up to processing to generate image data may be performed by the printer driver 51 of the host computer 50 side. In this case, the printer driver 51 determines whether or not there is a certain feeding tray 13b in the printer 10 (S215, S220) and creates-image data (S225, S245) that corresponds to selected feeding method (SEF or LEF) by, together with performing the determinations of S205 and S210 in accordance with the sheet size and printing method (two-sided or one-sided printing) specified by the user, performing communication with the printer 10 side as necessary. Then, the printer driver 51 sends the created image data to the printer 10, together with information on the specified size and printing method, and the selection result of the feeding method. As a result, the printer 10 performs printing of the image data by using the specified size, printing method and the selected feeding method.

### 4. Summary

In this way, according the present embodiments, the printer 10 is configured to be capable of using LEF or SEF as a feeding method and when the printer 10 performs printing on sheets of a small size that is smaller than the predetermined standard, in the case where two-sided printing has been specified, the printer 10 definitely performs two-sided printing using SEF and in the case where one-sided printing has been specified, the printer 10 preferentially performs LEF over SEF and performs printing. In other words, according to the present embodiments, together with a user being able to freely select two-sided printing or one-sided printing when performing printing on small sheets, by basically preferably performing LEF when performing one-sided printing, printing efficiency can be improved.

In FIGS. 2 and 8, although processing performed in the case where the specified size is not smaller than the predetermined standard (“No” in S105 and S205) has not been particularly described, in such a case the controller 12 determines whether to make the feeding method LEF or SEF in accordance with the specified size. That is, when the specified size is a size for which printing can only be performed with SEF due to the relation between the specified size and the maximum size E (for example, sizes such as A3, B4, Legal, Government Legal, Ledger (B) and F4), printing is performed using SEF, when the specified size is a size for which printing can be performed with either of SEF and LEF (for example, sizes such as A4, B5, Letter, Government Letter and Executive), LEF is preferentially performed, and in other cases, for media (envelopes having a flap, or the like) for which the feeding method to be used is determined on the basis of the structure of the sheet, feeding is performed by using the determined feeding method.

The entire disclosure of Japanese Patent Application No. 2008-322498, filed Dec. 18, 2008 is expressly incorporated by reference herein.

What is claimed is:

1. A printing apparatus that is capable of performing two-sided printing, comprising:
a sheet determining unit that determines whether a sheet size that has been instructed is smaller than a predetermined standard;
a one-sided/two-sided determining unit that determines whether one-sided printing or two-sided printing has been instructed; and
a printing/feeding control unit that, in a case where the sheet determining unit has determined that the sheet size is smaller than the predetermined standard and the one-sided/two-sided determining unit has determined that two-sided printing has been instructed, selects short-edge feeding for performing feeding of a sheet having an orientation in which short edges of the sheet are perpendicular to a feeding direction in the printing apparatus and performs printing on the sheet.

2. The printing apparatus according to claim 1, wherein, in a case where the sheet determining unit has determined that the instructed sheet size is smaller than the predetermined standard and the one-sided/two-sided determining unit has determined that one-sided printing has been instructed, the printing/feeding control unit, preferentially selects long-edge feeding for performing feeding of a sheet having an orientation in which the long edges of the sheet are perpendicular to the feeding direction in the printing apparatus, rather than short-edge feeding, and performs printing on the sheet.

3. The printing apparatus according to claim 1, further comprising a two-sided-printing transporting mechanism that turns over a sheet for which printing on one side thereof has been completed and transports the sheet to a predetermined printing start position, wherein the sheet determining unit determines that the sheet size is smaller than the predetermined standard in a case where a short edge of the sheet size is shorter than a distance between transport rollers included in the two-sided-printing transporting mechanism.

4. The printing apparatus according to claim 1, wherein the printing/feeding control unit, together with obtaining from outside image data that is oriented in a certain direction and that becomes a print target, in a case where a sheet orientation for the selected feeding and an orientation of the image data do not match, rotates the image data so that the sheet orientation and the orientation of the image data match, and performs printing on the sheet on the basis of the rotated image data.

5. The printing apparatus according to claim 1, wherein when the printing/feeding control unit obtains a print command from outside and creates image data by interpreting the print command, the printing/feeding control unit creates image data oriented in a direction that matches a sheet orientation for the selected feeding and performs printing on the sheet on the basis of the created print data.

6. The printing apparatus according to claim 1, wherein the printing/feeding control unit determines whether there is a sheet, in a predetermined feeding device, having an orientation that corresponds to a sheet orientation for the selected feeding and is of the sheet size that has been instructed, and in the case where there is such a sheet, the printing/feeding control unit causes the sheet to be fed from the feeding device and performs printing on the sheet, and in the case where there is no such sheet, the printing/feeding control unit makes a request to outside that such a sheet be provided to the feeding device.

7. The printing apparatus according to claim 6, wherein the printing/feeding control unit performs the determination of whether or not there is a sheet, in the feeding device, that has an orientation that corresponds to the sheet orientation for the selected feeding and is of the sheet size that has been instructed, after obtaining image data that is oriented in a direction that matches the sheet orientation for the selected feeding.

8. A printer driver that, in a computer, implements:
a sheet determining function that determines whether a sheet size that has been instructed is smaller than a predetermined standard;
a one-sided/two-sided determining function that determines whether one-sided printing or two-sided printing has been instructed; and
a control function that in a case where the sheet determining function has determined that the sheet size is smaller than the predetermined standard and the one-sided/two-sided determining function has determined that two-sided printing has been instructed, together with creating image data that is oriented in a direction that matches a sheet orientation for short-edge feeding for performing feeding of a sheet having an orientation in which short edges of the sheet are perpendicular to a feeding direction in a printing apparatus, causes two-sided printing of the image data and short-edge feeding to be performed in the printing apparatus, which is a control target, on a sheet of the sheet size.
